(19) United States
(12) Patent Application Publication
(10) Pub. No.: US 2023/0035440 A1
(43) Pub. Date: Feb. 2, 2023

(54) ELECTRONIC DEVICE, ELECTRONIC MUSICAL INSTRUMENT, AND METHOD THEREFOR

(71) Applicant: CASIO COMPUTER CO., LTD., Tokyo (JP)

(72) Inventors: Yukina ISHIOKA, Tokyo (JP); Yousuke ISHIOKA, Tokyo (JP)

(73) Assignee: CASIO COMPUTER CO., LTD., Tokyo (JP)

(21) Appl. No.: 17/847,599

(22) Filed: Jun. 23, 2022

(30) Foreign Application Priority Data
Jul. 30, 2021 (JP) 2021-125315

(51) Int. Cl. G10H 1/36; G10H 1/00; G10H 1/38

(52) U.S. Cl. CPC G10H 1/361; G10H 1/0008; G10H 1/383; G10H 2210/571; G10H 2210/005; G10H 2210/076

(57) ABSTRACT

In an electronic device for an electronic musical instrument, a determination grace period during which a plurality of operations on the electronic musical instrument by a user are determined to be simultaneously performed for the first section is set based on the data included in a first section of the song having a plurality of sections. Automatic accompaniment is advanced from the first section to the next second section when a user operation of the electronic musical instrument is detected outside of the determination grace period for the first section during the playback of the first section of the accompaniment, and automatic accompaniment is not advanced from the first section to the second section when the user operation of the electronic musical instrument is detected within the determination grace period for the first section during the playback of the first section of the accompaniment.

### BACKGROUND OF THE INVENTION

### Technical Field

The present invention relates to an electronic device, an electronic musical instrument, and method therefor.

### Background Art

Electronic musical instruments such as digital keyboards are equipped with a processor and a memory, and can be said to be an embedded computer or an electronic device with a keyboard. Some electronic musical instruments of this type can provide various ways of enjoying music in combination with an application running on the tablet terminal side as well as a function of playing song data (hereinafter collectively referred to as song (SONG) data). There are also known models that allow the user to take lessons by illuminating the keys on the keyboard the user is to play next.

“Easy lesson mode” is one of the lesson functions. When this mode is set, no matter which key is pressed, the playback position of the music data basically advances to the beginning of the next playback section at that moment.

For example, see Japanese Patent Application Laid-Open No. 2019-168592.

### SUMMARY OF THE INVENTION

In the easy lesson mode, it is conceivable to set a fixed set time as simultaneous key press determination grace period in order to prevent the playback position of the music data from advancing beyond the user's expectation. That is, even if a plurality of key presses are detected within this set time, the playback position of the music data is controlled so as not to advance to the next section.

However, if this grace period is fixed and short, there may be a case where the playback position of the music data advances more than the user expected, especially when the user plays with both hands. Further, if this grace period is set too long, the playback position of the music data does not advance as the user expects.

The present invention has been made in such circumstances, and can provide an electronic device, an electronic musical instrument, and a method in which music data is adequately played back according to the user's performance operations.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides an electronic device, comprising: at least one processor, said at least one processor being configured to perform the following: instructing playback of an accompaniment of a song based on a data of the song, the song having a first section and a second section that follows the first section; setting a determination grace period during which a plurality of operations on an electronic musical instrument by a user are determined to be simultaneously performed for the first section based on the data included in the first section of the music; advancing the playback of the accompaniment from the first section to the second section when a user operation of the electronic musical instrument is detected outside of the determination grace period for the first section during the playback of the first section of the accompaniment; and causing the playback of the accompaniment not to advance from the first section to the second section when the user operation of the electronic musical instrument is detected within the determination grace period for the first section during the playback of the first section of the accompaniment.

In another aspect, the present disclosure provides an electronic musical instrument, comprising: the above-described electronic device; and an performance controller that receives the user operations.

In another aspect, the present disclosure provides a method to be performed by at least one processor in an electronic device, the method comprising, via the at least one processor: instructing playback of an accompaniment of a song based on a data of the song, the song having a first section and a second section that follows the first section; setting a determination grace period during which a plurality of operations on an electronic musical instrument by a user are determined to be simultaneously performed for the first section based on the data included in the first section of the music; advancing the playback of the accompaniment from the first section to the second section when a user operation of the electronic musical instrument is detected outside of the determination grace period for the first section during the playback of the first section of the accompaniment; and causing the playback of the accompaniment not to advance from the first section to the second section when the user operation of the electronic musical instrument is detected within the determination grace period for the first section during the playback of the first section of the accompaniment.

According to the present invention, it is possible to provide an electronic device, an electronic musical instrument, and a method in which music data is adequately played back according to the user's performance operations.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is an external view showing an example of an electronic musical instrument according to an embodiment.

FIG. 2 is a block diagram showing an example of the digital keyboard 1 shown in FIG. 1.

FIG. 3 is a functional block diagram showing an example of the RAM 12, ROM 13 and processor 22 of FIG. 2.

FIG. 4 is a conceptual diagram for explaining the song data 13b.

FIG. 5 is a flowchart showing an example of the main routine in the easy lesson mode according to an embodiment.

FIG. 6 is a flowchart showing an example of correct answer information generation processing.

FIG. 7 is a flowchart showing an example of keyboard input processing.

FIG. 8 is a flowchart showing an example of the keyboard determination process.

FIG. 9 is a flowchart showing an example of the determined chord event simultaneous key press determination grace period setting process.

FIG. 10 is a flowchart showing an example of the determined note event simultaneous key press determination grace period setting process.

FIG. 11 is a diagram for explaining the processing of the processor 22 immediately after the start of accompaniment.

FIG. 12 is a diagram for explaining a process when a key press event occurs between the timing t1a and the timing t2 of FIG. 11.

FIG. 13 is a diagram for explaining the processing of the processor 22 during the performance.

FIG. 14 is a diagram for explaining a process when a key press event occurs at the timing tₙ₊₁ of FIG. 13.

### DETAILED DESCRIPTION OF EMBODIMENTS

### Glossary

### (Tick)

The tick is a unit used to express the length of time in this field of art, and can be used, for example, to express the difference in the timing of occurrence of a plurality of events. The tick changes according to the tempo of the song and the like. The tick is a unit used in a sequencer or the like based on the tempo of a song. For example, if the resolution of the sequencer is 480, 1/480 of a quarter note time is 1 tick. The resolution of the following embodiments may differ from 480. Moreover, the tick number of the following embodiment is only an example.

### EMBODIMENTS

Hereinafter, embodiments of the present invention will be described with reference to the drawings. Prior to the explanation of the configuration, circumstances where the automatic accompaniment proceeds regardless of the intention of the user (performer) will be explained. As mentioned above, in certain lesson modes, automatic accompaniment advances whenever any key press is detected if there is an outstanding key press operation. The next keys to be played is indicated by the blinking key on the keyboard, but even if a non-blinking key is pressed, the playback of the song will not stop or pause. Then, a difference in the timing of pressing a plurality of keys becomes a problem. The following two patterns are mainly considered.

### [Pattern 1]

Pattern 1 is an example that does not consider the variation tolerance period. In the easy lesson mode, at least two keys are pressed almost at the same time, especially when playing with both hands, and a grace period is required to consider the timings of these key presses as the same event. If the grace period can be changed in real time according to the number of ticks between events, the number of notes (notes) of the event, and the tempo (tempo), it may be possible to provide a more satisfying playing experience for the performer.

### [Pattern 2]

Pattern 2 is an example closer to the actual implementation, which takes into account the variation tolerance period. In the existing technique, a period (variation tolerance period) is provided to allow slight variations in the key press timing in consideration of the case where a plurality of events exist within several ticks on the data such as ornamental sounds. However, the length of such a period is fixed, and only a very short minimum number of ticks is set. For this reason, in a song with a fast tempo or a scene with a large number of key presses, the deviation of the key press timings is strictly determined, and as a result of being regarded as multiple key press events, the song advances much more than the user's expectation.

Therefore, apart from the variation judgment period, a grace period is required to regard multiple key presses as the same event. If the grace period can be changed in real time according to the number of ticks between events, the number of notes (notes) of the event, and the tempo (tempo), it may be possible to provide a more satisfying playing experience for the performer.

<Configuration>

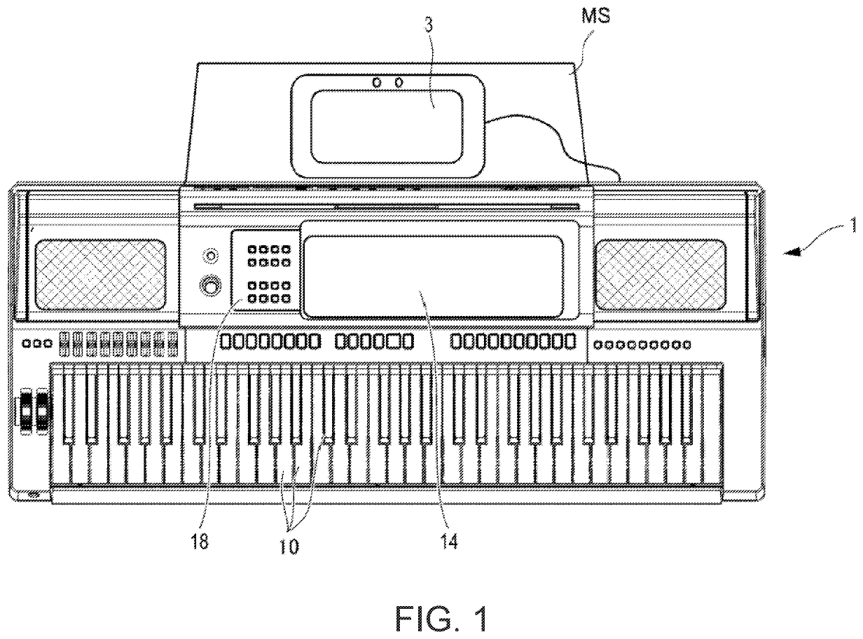

FIG. 1 is an external view showing an example of an electronic musical instrument according to an embodiment. In FIG. 1, the digital keyboard 1 as an electronic musical instrument is, for example, an electronic keyboard instrument such as an electronic piano, a synthesizer, or an electronic organ. The digital keyboard 1 can also be regarded as an electronic device with a keyboard. The electronic device is a computer. The electronic device may be built in the electronic musical instrument. Further, the electronic device may be a portable terminal device including a tablet computer, separate from the electronic musical instrument.

The digital keyboard 1 includes a plurality of keys 10 arranged on the keyboard, a display unit 14, an operation unit 18, and a music stand MS. Further, the digital keyboard 1 can be connected to the tablet 3 via wire or wirelessly. As shown in FIG. 1, the tablet 3 can be placed on the music stand MS to display the score of the music stored in the digital keyboard 1 or to be used as an operation interface.

In FIG. 1, the display unit 14 is provided with, for example, a liquid crystal display (LCD) with a touch panel, and displays a message accompanying the operation of the operation unit 18 of the performer, a lesson mode selection list, and the like. When the display unit 14 has a touch panel function, the display unit 14 can play a part of the functions of the operation unit 18.

The operation unit 18 has operation buttons, dials, and the like for the performer to make various settings and the like. The user can perform various setting operations such as volume adjustment by operating these operation buttons and dials. The user can use the operation buttons to select, for example, whether to use or not to use the lesson mode, and to perform various setting operations such as volume adjustment.

The keys 10 are operators (performance elements; i.e., a performance controller) for the performer to specify a pitch(es). When the performer presses/releases the key 10, the digital keyboard 1 generates/mutes the sound corresponding to the designated pitch. Pressing and releasing keys are examples of performance operations. Each of such operations can be regarded as a performance operation individually, or a set of key press/release operations can be regarded as one performance operation. Alternatively, only a key press event may be captured and counted as an individual performance operation, or only a key release event may be regarded as a performance operation. For example, an event that triggers the generation of performance data can be regarded as a performance operation. All actions that generate performance data may be regarded as performance operations, or only actions that generate certain types of performance data (note-on, note-off, etc.) may be regarded as performance operations.

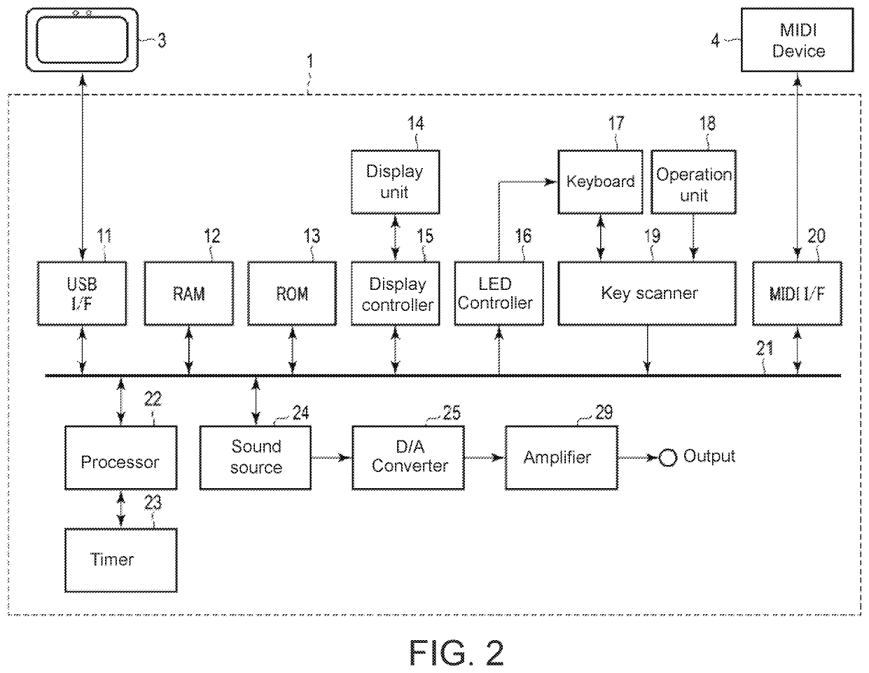

FIG. 2 is a block diagram showing an example of the digital keyboard 1 shown in FIG. 1. The digital keyboard 1 includes a USB interface (I/F) 11, a RAM (Random Access Memory) 12, a ROM (Read Only Memory) 13, a display unit 14, a display controller 15, an LED (Light Emitting Diode) controller 16, a keyboard 17, an operation unit 18, key scanner 19, MIDI (Musical Instrument Digital Interface) interface (I/F) 20, system bus 21, processor 22, timer 23, sound source 24, digital/analog (D/A) converter 25, and amplifier 29.

The processor 22, the sound source 24, the USB interface 11, the RAM 12, the ROM 13, the display controller 15, the LED controller 16, the key scanner 19, and the MIDI interface 20 are connected to the system bus 21.

The processor 22 is provided at least one and is an arithmetic processing device such as a CPU (Central Processing Unit) and an MPU (Micro Processing Unit). The processor 22 reads a program(s) stored in the ROM 13 into the RAM 12 and executes it to realize various functions of the digital keyboard 1. The processor 22 operates according to the clock supplied from the timer 23. The clock is used, for example, to control the sequence of automatic accompaniment.

ROM 13 stores programs, various setting data, song data, and the like. Here, the song data may include preset rhythm patterns, chord progressions, bass patterns, data representing obbligato, and the like. The song data may include pitch information of each note, sound generation timing information of each note, and the like.

The song data may be stored in an information storage device or an information storage medium (not shown) instead of ROM 13. The format of the song data may conform to the file format for MIDI.

The display controller 15 is an IC (Integrated Circuit) that controls the display state of the display unit 14. The LED controller 16 is, for example, an IC. The LED controller 16 illuminates the keys of the keyboard 17 according to the instructions from the processor 22 to navigate the performance of the performer.

The key scanner 19 constantly monitors the key press/release state of the keyboard 17 and the switch operation state of the operation unit 18. The key scanner 19 conveys the monitored state of the keyboard 17 and the operation unit 18 to the processor 22.

The MIDI interface 20 inputs MIDI data (performance data, etc.) from an external device such as the MIDI device 4, and outputs MIDI data to the external device. The digital keyboard 1 can exchange MIDI data and music files with an external device by using an interface such as USB (Universal Serial Bus). The received MIDI data is passed to the sound source 24 via the processor 22. The sound source 24 produces a sound according to a tone color, volume (velocity), timing, etc., specified by MIDI data.

The MIDI data (MIDI message) can represent any information about the performance of a song, such as information on pitch number and tone number corresponding to the key 10, as well as information indicating timing such as note-on and note-off, intensity information called velocity, and various control information.

The sound source 24 is a specific arithmetic processing device such as a DSP (Digital Signal Processor). The sound source 24 is, for example, a so-called GM sound source that conforms to the GM (General MIDI) standard. This kind of sound source can change the timbre by providing it with a program change as a MIDI message included in the MIDI data. Further, the default effect can be changed by providing it with a corresponding control change.

The sound source 24 has the ability to generate a maximum of 256 voices, for example, at the same time. The sound source 24 reads, for example, musical tone data from a waveform ROM (not shown) and outputs the digital musical tone waveform data to the D/A converter 211. The D/A converter 211 converts the digital musical tone waveform data into an analog musical tone waveform signal. This analog musical tone waveform signal is amplified by the amplifier 29 and output from an output terminal such as a speaker or a headphone out.

For example, the tablet 3 can be connected to the system bus 21 via the USB interface 11. The tablet 3 can acquire MIDI data (performance data) generated by playing the digital keyboard 1 via the USB interface 11.

Further, it is also possible to connect a storage medium such as a USB memory to the system bus 21 via the USB interface 11. By storing the program in the storage medium and reading it into the RAM 12, the processor 22 can execute the same operation as when the program is stored in the ROM 13.

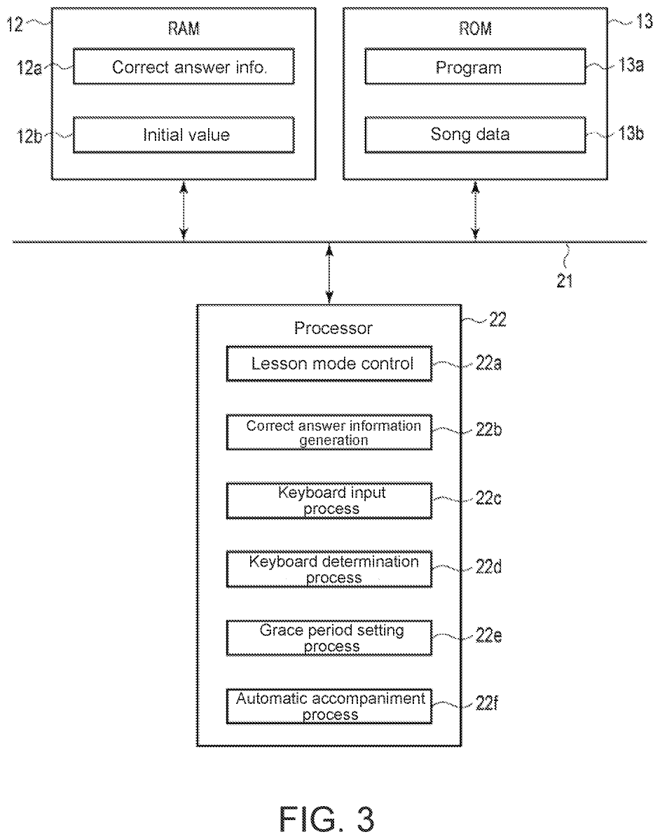

FIG. 3 is a functional block diagram showing an example of the RAM 12, ROM 13 and processor 22 of FIG. 2.

In this embodiment, as processing functions, the processor 22 includes a lesson mode control part 22a, a correct answer information generation processing part 22b, a keyboard input processing part 22c, a keyboard determination processing part 22d, a grace period setting processing part 22e, and an automatic accompaniment processing part. 22f. These functional blocks are processes generated by the execution of the program 13a stored in the ROM 13.

The lesson mode control part 22a switches the mode of the digital keyboard 1 according to the user operation on the operation unit 18. The following disclosure describes the details of an easy lesson mode.

The correct answer information generation processing part 22b generates correct answer information triggered by a key press operation (hereinafter collectively referred to as a keyboard event; the keyboard event includes note-on, note-off, etc.) and stores it in the RAM 12 (correct answer information 12a). The correct answer information is simply “note number to be pressed and its timing”, and is generated for each section in the music. Here, the note number represents a pitch and is data associated with an identifier (ID) of a key in the keyboard 10.

The keyboard input processing part 22c detects the occurrence of a keyboard event. When the occurrence of a keyboard event is detected, the keyboard input processing part 22c notifies the keyboard determination processing part 22d of that fact.

The keyboard determination processing part 22d performs keyboard determination processing based on the notification from the keyboard input processing part 22c. The details of the keyboard determination process will be described later.

The grace period setting processing part 22e sets a grace period. It performs processing to set a “grace period” that serves as a reference for determining whether to handle multiple key-on events as “same event” or “different events”. In the conventional technology, the “grace period” was fixed. But in the present embodiment, the “grace period” is dynamically changed, as will be described in detail below. The initial value of the grace period is stored in advance in the RAM 12 (initial value 12b).

The automatic accompaniment processing part 22f reads the song data 13b of the music designated by the user from the ROM 13 and performs automatic accompaniment according to the song data.

The ROM 13 stores the program 13a and the song data 13b of the present embodiment. The program 13a causes the processor 22 to execute the functions of the lesson mode control part 22a, the correct answer information generation processing part 22b, the keyboard input processing part 22c, the keyboard determination processing part 22d, and the grace period setting processing part 22e. The song data 13b is preset data or data input by the user, and is basic data for performing automatic accompaniment.

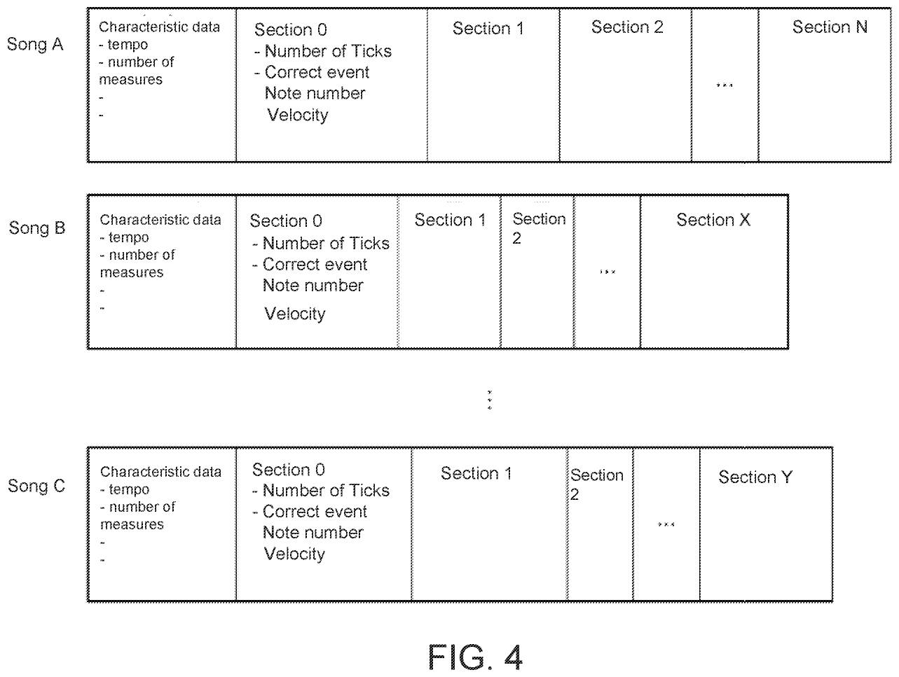

FIG. 4 is a conceptual diagram for explaining the song data 13b. As shown in FIG. 4, the song data of each song includes characteristic data and a plurality of consecutive sections in time series. The respective sections are counted from zero origin to form a sequence as the 0th section, the 1st section, the 2nd section, and so on. In most cases, the 0th section is the intro, and the lesson is triggered by the first note-on operation during this section. In this embodiment, the unit of length to define each section is “tick”. Most of the sections have lengths of several to several tens of ticks—at most several hundred ticks—so that they are on the order of nanoseconds to milliseconds in terms of time.

The characteristic data includes data representing, for example, the tempo of a song, the number of measures, a preset rhythm pattern, a chord progression, a bass pattern, an obligado, and the like.

Each section includes data such as the number of ticks of the section length and correct event. The correct event also includes information on note number, velocity, and timing of each note to be played, for example.

<Operation>

Next, the operation of the above configuration will be described. In the following, the “grace period” is referred to as a “simultaneous key press determination grace period”.

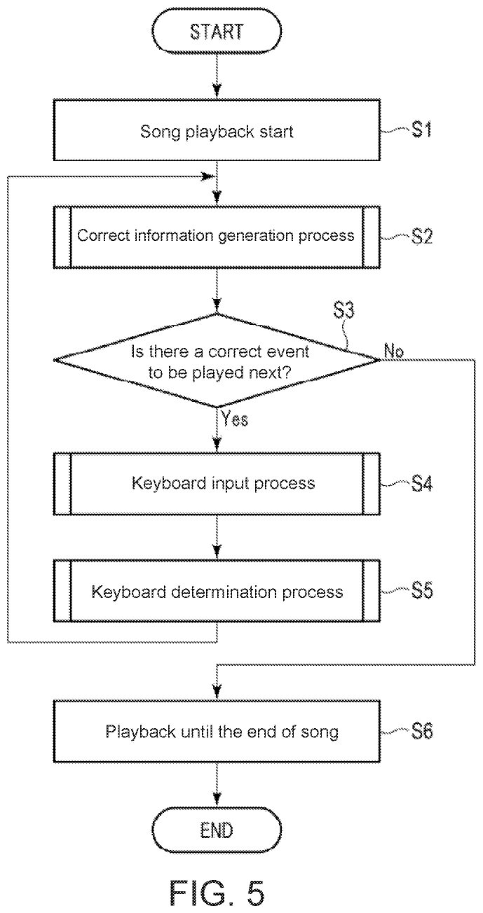

FIG. 5 is a flowchart showing an example of the main routine in the easy lesson mode according to this embodiment. With reference to FIG. 5, the basic process flow in the easy lesson mode will be described.

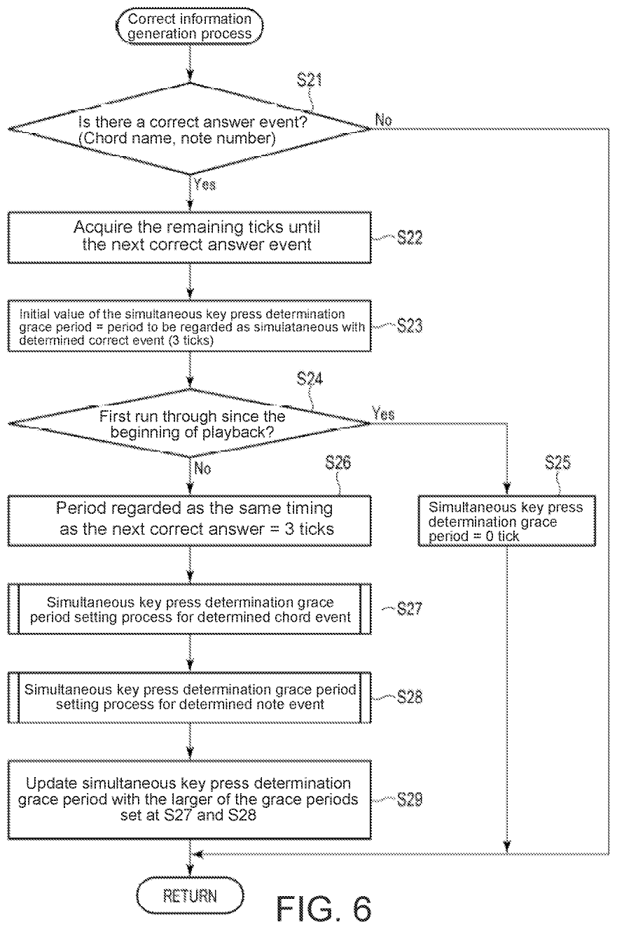

When the playback of the song (accompaniment) designated by the user operation is started in step S1, the processor 22 executes the correct answer information generation process (step S2). That is, the correct answer information generation processing part 22b (FIG. 3) acquires the correct answer event to be played by the user from the song data 13b and generates correct answer information. The generated correct answer information is stored in the RAM 12 (correct answer information 12a). The details of step S2 will be described later with reference to FIG. 6.

Next, the processor 22 determines whether or not there is a correct answer event to be played next (step S3), and if there is no such event (No), the processor 22 continues the playback until the end of the song because there are no more chords or notes to be played (step S6). If there is a correct answer event to be played next (Yes), the processing procedure proceeds to step S4.

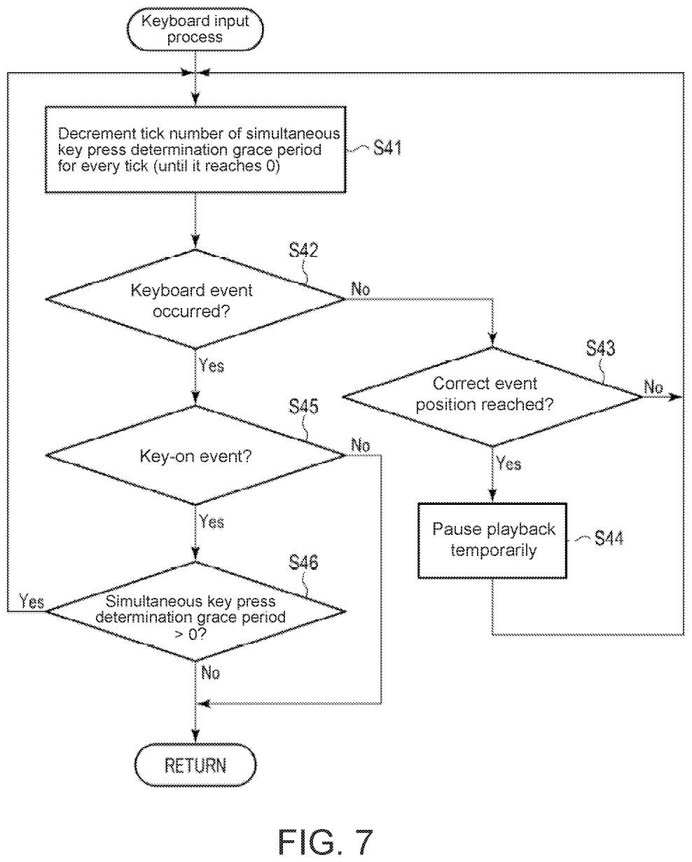

In step S4, the processor 22 executes the keyboard input process. When it is determined that some keyboard input operation has been performed, the processing procedure proceeds to step S5. The details of step S4 will be described later with reference to FIG. 7.

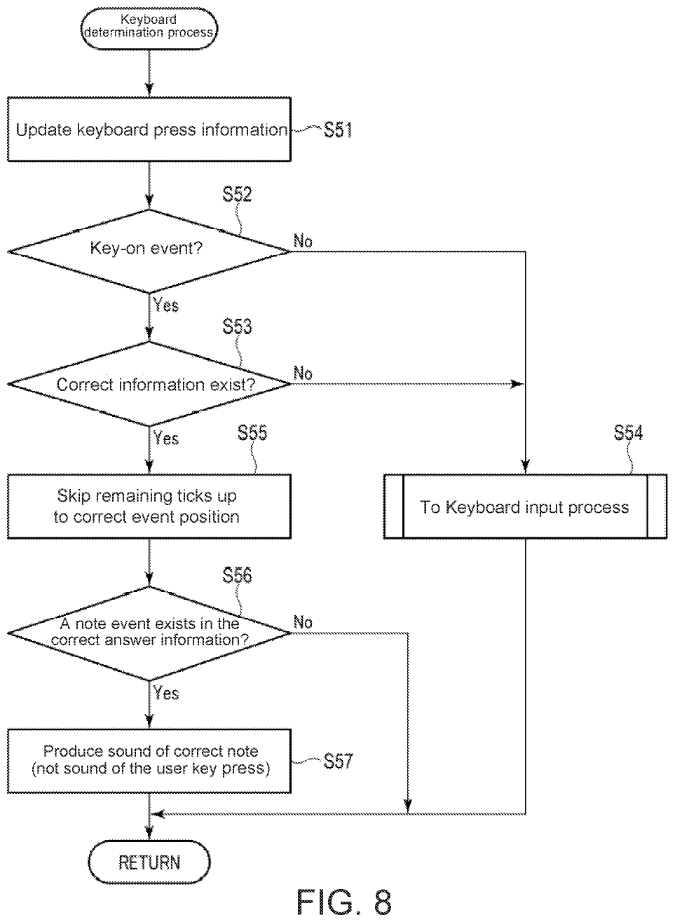

In step S5, the processor 22 executes the keyboard determination process. The details of step S5 will be described later with reference to FIG. 8. Then, the processes of step S2 to step S5 are repeated until there is no correct answer event to be played next (No in step S3).

<Correct Answer Information Generation Process>

FIG. 6 is a flowchart showing an example of the process of step S2 (correct answer information generation process) of FIG. 5. In FIG. 6, the processor 22 first determines whether or not there is a correct answer event (step S21), and if there is no correct answer event (No), the processing procedure returns to the caller (RETURN). If there is a correct answer event (Yes), the processor 22 acquires the number of remaining ticks until the next correct answer event (step S22). That is, the processor 22 acquires information about the event to be played next, which is the closest to the current playback position. That is, the processor 22 acquires the data related to the next section by reading the next section of the song data 13b, and uses it as the correct answer information. Examples of the data related to the next section include data such as the number of ticks remaining until the next correct answer event, a chord name, a note number, fingering, a set of keys that are to be blinking, and velocity.

Next, the processor 22 sets 3 ticks as the initial value of the simultaneous key press determination grace period in consideration of the case where the event position of the correct answer information data varies (decorative note, etc.; corresponding to pattern 2 above) (step S23). That is, the minimum required number of ticks (here, 3 ticks) is set as the variation tolerance period. In the case of pattern 2, this value corresponds to the variation tolerance period of the determined correct answer event.

Next, the processor 22 determines whether or not the current process run is the first run after the start of playback of the automatic accompaniment (step S24), and if so (Yes), substitutes 0 tick for the simultaneous key press determination grace period (step S25). That is, the processor 22 sets the initial value of the simultaneous key press determination grace period to 0 when the correct answer information is acquired for the first time after the start of playback, and then the processing procedure returns to the caller (RETURN).

If this is not the first run (No in step S24), the processor 22 assigns 3 ticks to the variable indicating the period (variation tolerance period) considered to be the same timing as the next correct answer timing (step S26).

Next, the processor 22 executes the simultaneous key press determination grace period setting process for the determined chord event (step S27) and the simultaneous key determination grace period setting process for the determined note event (step S28). Then, the processor 22 updates the value of the simultaneous key press determination grace period with the larger of the simultaneous key determination grace periods set in the steps S27 and S28 (step S29).

<Keyboard Input Processing>

FIG. 7 is a flowchart showing an example of the process of step S4 (keyboard input process) of FIG. 5. In the main routine of this process, until the key press event occurs by the correct timing, the processor causes the playback of the automatic accompaniment to be paused (with the last sound of the accompaniment continuing) and waits for a key press operation. Meanwhile, the processor 22 decrements the tick number of the simultaneous key press determination grace period obtained in the procedure of FIG. 6 for each tick cycle (step S41).

The processor 22 waits for the occurrence of a keyboard event (step S42), and unless a keyboard event occurs (No in step S42), the tick number of the simultaneous key press determination grace period is decremented until 0 is reached. If the correct event position is reached without a keyboard event (Yes in step S43), the playback of the automatic accompaniment is paused temporarily (step S44) and the process continues to wait for the occurrence of a keyboard event.

When a keyboard event occurs (Yes in step S42), the processor 22 determines whether or not it is a key-on event (step S45), and if it is a key-off event (No), the processing procedure returns to the caller and moves to the next keyboard determination process.

If it is a key-on event in step S45 (Yes), the processor 22 determines whether or not the simultaneous key press determination grace period is greater than 0 (step S46). Here, if the simultaneous key press determination grace period >0 (Yes), it is determined that this key-on event is within the simultaneous key determination grace period. That is, it is concluded that the generated key-on event occurred at the same timing as the immediately preceding key-on event, and the processing procedure returns to step S41. As a result, the process of skipping the performance is omitted.

On the other hand, if the simultaneous key press determination grace period ≤0 in step S46, it is determined that this key-on event is outside the simultaneous key press determination grace period, and the processing procedure returns to the caller and moves to the next keyboard determination process.

<Keyboard Determination Processing>

FIG. 8 is a flowchart showing an example of the process of step S5 of FIG. 5 (keyboard determination process). In FIG. 8, the processor 22 first updates the keyboard information (key-pressing information) of the keys currently being pressed by the user (step S51), and then determines whether or not to proceed with the automatic accompaniment. That is, it is determined whether or not there is a key-on event (step S52), and if no, it is a key-off event. Since it is not necessary to advance the song when a key-off event occurs, the processing procedure returns to the caller (step S54) and waits for the keyboard input again.

If the keyboard event is an key-on event (Yes in step S52), the processor 22 determines whether or not there is correct answer information (step S53). If there is correct answer information (Yes), the processor 22 jumps the number of remaining ticks up to the correct answer event position (step S55). In other words, when a key-on event is given, the song always advances without comparison between the correct answer information and the user operation event. Only when the correct answer information exists, the keyboard input processing and the keyboard determination processing are performed. Therefore, this means that the correct answer information exists at this point.

Next, the processor 22 determines whether or not a note event exists in the correct answer information (step S56). If Yes, the processor 22 causes sound generation of the note of the correct answer information as a keyboard tone instead of the sound of the key pressed by the user (step S57). As a result, no matter which key is pressed, the notes according to the song data 13b can be played back without fail.

<Simultaneous Key Press Determination Grace Period Setting Process for Determined Chord Event>

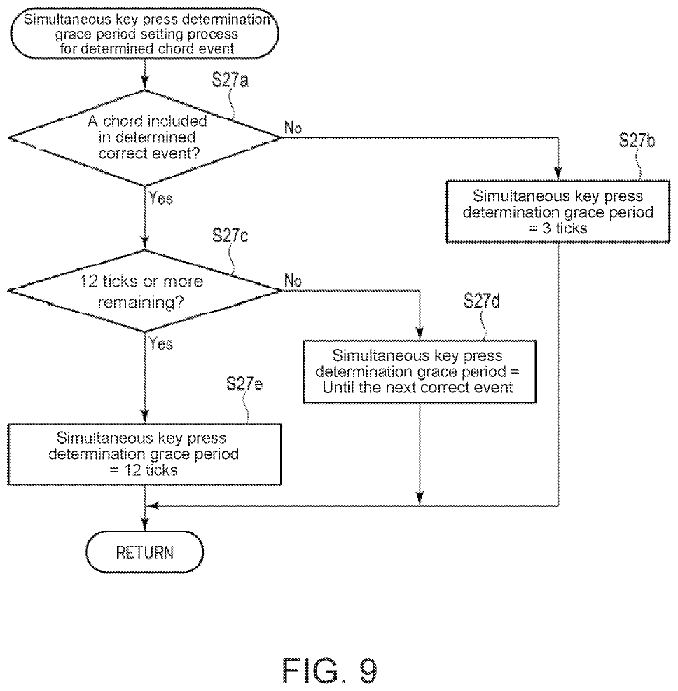

FIG. 9 is a flowchart showing an example of the process of step S27 of FIG. 6 (Simultaneous key press determination grace period setting process for determined chord event). This procedure is executed, for example, when a song in which a chord is to be played with the left hand and a melody is to be played with the right hand is selected in the easy lesson mode.

In FIG. 9, the processor 22 checks whether or not the determined correct answer event contains a chord (step S27a), and if the chord is included (Yes), the processor 22 compares the number of remaining ticks until the next event with a reference value (for example, 12 ticks) (step S27c). If the number of remaining ticks 12 ticks, the processor 22 sets this reference value in the “simultaneous key press determination grace period” (step S27e).

If No in step S27c, that is, if the remaining ticks <12 ticks, the processor 22 sets the remaining ticks until the next correct answer event in the “simultaneous key press determination grace period” (step S27d), and the processing procedure returns the caller. This way, even if the number of remaining ticks is less than the reference number of ticks, at least the remaining number of ticks can be secured.

On the other hand, if there is no chord in the determined correct answer event (No) in step S27a, the processor 22 sets the initial value of 3 ticks in the “simultaneous key press determination grace period” (step S27b), and the processing procedure returns to the caller.

<Simultaneous Key Press Determination Grace Period Setting Process for Determined Note Events>

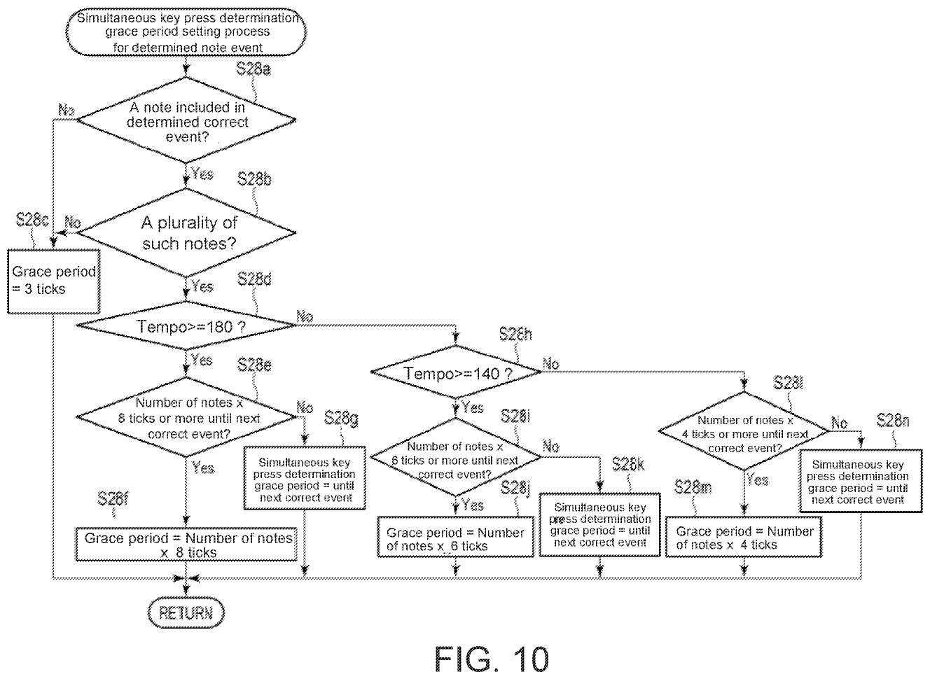

FIG. 10 is a flowchart showing an example of the process of step S28 of FIG. 6 (simultaneous key press determination grace period setting process for determined note event). This processing procedure is executed, for example, in the easy lesson mode when a plurality of notes are included in the correct answer event of the same timing.

In FIG. 10, when the determined correct answer event includes a note (Yes in step S28a), the processor 22 checks whether or not a plurality of such notes are included in the determined correct answer event (step S28b). If No in any of these steps, the processor 22 sets the initial value of 3 ticks in the “simultaneous key press determination grace period” (step S28c), and the processing procedure returns to the caller.

When a plurality of notes are included in the determined correct answer event (Yes in step S28b), the processor 22 acquires the tempo information (tempo) of the song from the song data 13b and refers to it (steps S28d, S28h).

For example, the tempos used as references are set in advance over multiple ranges such as “fast”, “slightly fast”, and “normal”, and the reference unit tick is set to “X”, “Y”, and “Z”, respectively. For example, a tempo reference value is set such as [fast=180 bpm or more], [slightly fast=140 bpm or more], and [normal=less than 140 bpm]. At the tempo of each range, the reference unit tick number is set to, for example, X=8, Y=6, Z=4 so that the faster the tempo, the longer the number of ticks in the grace period.

If the tempo is 180 bpm or more in step S28d (Yes), the processor 22 determines whether or not the period until the next correct answer event is (number of notes×8 ticks) or more (step S28e). That is, X=8. If Yes in step S28e, the processor 22 sets (number of notes×8 ticks) in the “simultaneous key press determination grace period” (step S28f). If No in step S28e, the processor 22 sets the tick number until the next correct answer event in the “simultaneous key press determination grace period” (step S28g), and the processing procedure returns to the caller.

If the tempo is less than 180 bpm in step S28d (No), the processor 22 determines whether or not the tempo is 140 bpm or more (step S28h). If the tempo is 140 bpm or more (Yes), the processor 22 determines whether or not the period until the next correct answer event is (number of notes×6 ticks) or more (step S28i). That is, Y=6. If Yes in step S28i, the processor 22 sets (number of notes×6 ticks) in the “simultaneous key press determination grace period” (step S28j). If No in step S28i, the processor 22 sets the number of ticks until the next correct answer event in the “simultaneous key press determination grace period” (step S28k), and the processing procedure returns to the caller.

Further, if the tempo is less than 140 bpm in step S28h (No), the processor 22 determines whether or not the period until the next correct answer event is (number of notes×4 ticks) or more (step S281). That is, Z=4. If Yes in step S281, the processor 22 sets (number of notes×4 ticks) in the “simultaneous key press determination grace period” (step S28m). If No in step S281, the processor 22 sets the tick number until the next correct answer event in the “simultaneous key press determination grace period” (step S28n), and the processing procedure returns to the caller.

This way, “number of notes×reference unit ticks” is calculated according to the tempo range, and if the remaining ticks are far from this value, it is applied to the “simultaneous key press determination grace period”. Similar to FIG. 9, when the number of remaining ticks is less than “number of notes×reference unit tick”, the remaining ticks are secured. By executing the flowcharts of FIGS. 9 and 10 in this order, the larger one is selected by comparing the respective “simultaneous key press determination grace periods”.

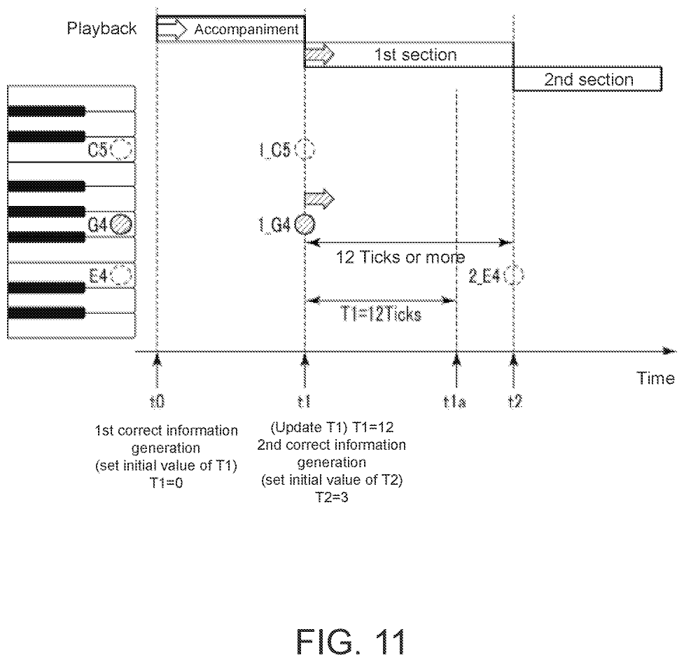

FIG. 11 is a diagram for explaining the processing of the processor 22 immediately after the start of accompaniment. In FIG. 11, the passage of time is represented by an arrow pointing to the right. As shown in the drawing, for example, a plurality of sections are set for respective notes of the piano part played by the user. The positions and lengths of these sections are registered in advance in the song data 13b (FIG. 4). The song data 13b includes not only the piano part but also the data of other parts.

In FIG. 11, when the instruction to start playing is received, the processor 22 instructs the sound source 24 to start playing back the accompaniment (intro) from the timing t0. At the same time, the processor 22 generates the first correct answer information (that is, a plurality of keys of C5 and G4 are to be pressed), and sets T1=0 as the initial value of the simultaneous key press determination grace period T1.

When the key press of 1_G4 is detected at the timing t1 following the timing t0, the processor 22 instructs the start of playback of the first section (note that 1_C5 is not pressed at the timing t1 and this is indicated by a dotted line (indicated by 0)). At the same time, the processor 22 confirms that the timing is for multiple key press operation by referring to the first correct answer information, and acquires the number of remaining ticks up to the start timing of the second section. In the example of FIG. 11, since 12 ticks or more are remaining, the processor 22 updates the simultaneous key press determination grace period T1 as T1=12. Further, the processor 22 generates the second correct answer information (a single key to be pressed only for E4, i.e., no multiple keys are to be pressed), and sets T2=3 as the initial value of the simultaneous key pressing determination grace period T2.

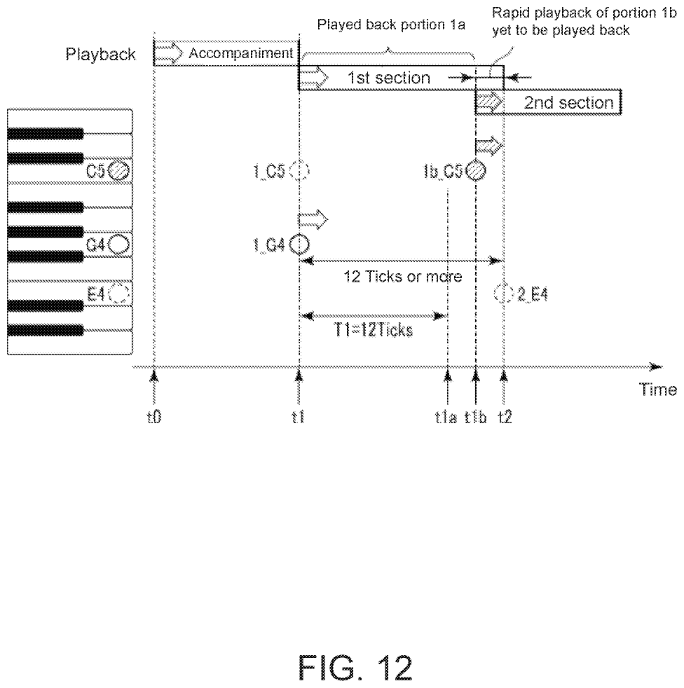

FIG. 12 is a diagram for explaining a process when a key press event occurs between the timing t1a and the timing t2 of FIG. 11. When the key press event of 1b_C5 at the timing t1b is detected after the timing t1a has passed, the processor 22 instructs the high-speed playback of the section 1b that has not been played back in the first section and the start of the playback of the second section. As a result, the playback start timing of the second section is earlier than the designed playback start timing. Here, since the timing t1 to the timing t1a are within the simultaneous key pressing determination grace period, the playback start of the second section is not instructed even if a key press event is to occur during that period.

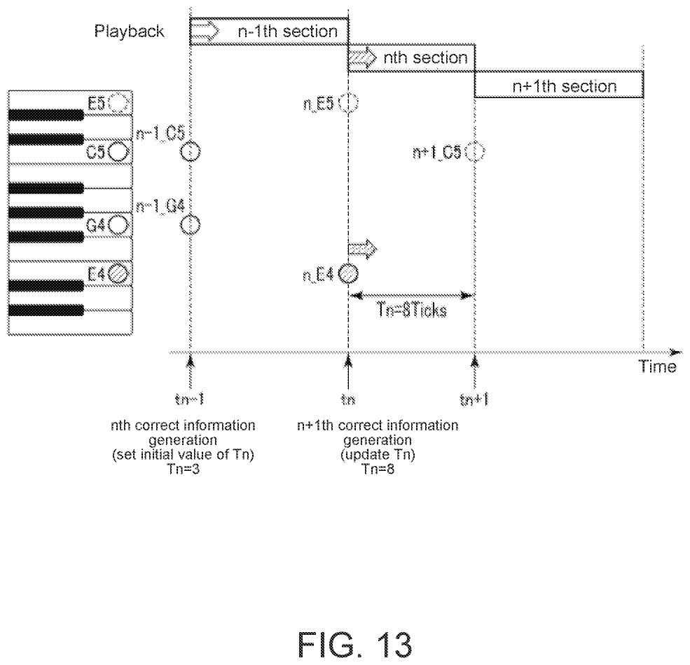

FIG. 13 is a diagram for explaining the processing of the processor 22 during the performance. In FIG. 13, when the key press is detected at the timing tₙ₋₁ during the playback of the automatic performance, the processor 22 generates the nth correct answer information (i.e., a plurality of keys of E5 and E4 are to be pressed in this example) in the next section, and Tₙ=3 is set as the initial value of Tₙ.

When the key press event of n_E4 is detected at the subsequent timing tₙ, the processor 22 instructs the start of playback of the nth section. At the same time, the processor 22 confirms that the timing is for multiple key press operation by referring to the nth correct answer event, and acquires the remaining tick numbers up to the start timing of the n+1th section. In the example of FIG. 13, since 8 Ticks is less than 12 Ticks, the processor 22 updates the simultaneous key press determination grace period Tn of the nth section as Tn=8. Further, the processor 22 generates the n+1 correct answer event (a single key to be pressed only for C5, i.e., no multiple key is to be pressed), and sets Tₙ₊₁=3 as the initial value of the simultaneous key pressing determination grace period Tn+1.

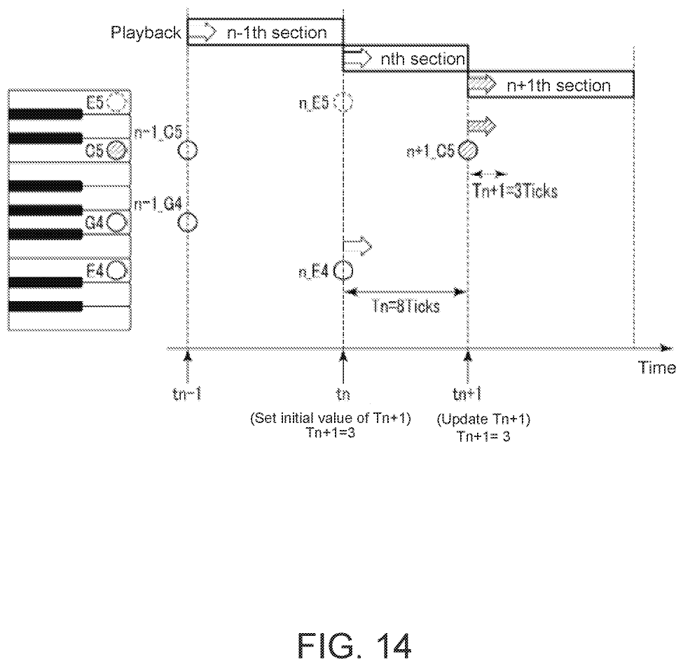

FIG. 14 is a diagram for explaining a process when a key press event occurs at the timing tₙ₊₁ of FIG. 13. When, for example, a key press event of n+1_C5 is detected at the timing tₙ₊₁, the processor 22 refers to the n+1th correct answer event and confirms that the key press timing is not for multiple key operation. As a result, the simultaneous key press determination grace period Tₙ₊₁ in the n+1th section is not updated and Tₙ₊₁=3 remains true.

As described above, in this embodiment, even if two performance operations (keyboard events) of the first performance operation and the second performance operation are detected, if they are within the simultaneous key press determination grace period, they are regarded as a single performance operation, and only the first section is played back, and the playback of the next second section is not started. Further, in this embodiment, a plurality of the determination grace periods that can have different lengths can be set in real time for the respective sections during the performance.

In the mode in which the next yet-to-be played back section of a song having a plurality of sections is played for each performance operation detection (i.e., in the easy lesson mode), the first section is played in response to the detection of the first performance operation, and in response to the detection of the second playing operation during the playback of the first section, the remaining yet-to-be played portion of the first section is reproduced at high speed (alternatively, that portion may be skipped without being played back at high speed), and then the playback of the second section is started. Here, if the second performance operation is not detected even after the playback of the first section is completed, the playback of the second section is not started.

In the conventional technology, the timing of key press operation must be very strict. The main reason for this is that the criteria for determining/detecting events are fixed. On the other hand, in this embodiment, in the easy lesson mode, the length of the period that is regarded as the simultaneous key press events (simultaneous key press determination grace period) is dynamically set for each section of the song on the basis of at least one of the number of notes in the determined correct answer event, the number of ticks until the next correct answer event and the tempo of the song.

Therefore, according to the present embodiment, in the easy lesson mode (with both hands especially), the performer can perform music closer to the natural feeling of the performer than in the conventional art. Therefore, according to the embodiment, it is possible to provide an electronic device, an electronic musical instrument, a method, and a program in which music data is satisfactorily played back according to a user's performance operation. In other words, it is possible to prevent the automatic accompaniment from progressing unintentionally, which in turn makes playing even more enjoyable.

The present invention is not limited to the specific embodiment described above, and the technical scope of the present invention includes various modifications and improvements within the range in which the object of the present invention can be achieved. The first section and the second section expressed in the claims mean any arbitrary section in the music. That is, the first section may be the middle section of the music. Further, the second section may be the last section of the music.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. An electronic device, comprising:
at least one processor, said at least one processor being configured to perform the following:
instructing playback of an accompaniment of a song based on a data of the song, the song having a first section and a second section that follows the first section;
setting a determination grace period during which a plurality of operations on an electronic musical instrument by a user are determined to be simultaneously performed for the first section based on the data included in the first section of the music;
advancing the playback of the accompaniment from the first section to the second section when a user operation of the electronic musical instrument is detected outside of the determination grace period for the first section during the playback of the first section of the accompaniment; and
causing the playback of the accompaniment not to advance from the first section to the second section when the user operation of the electronic musical instrument is detected within the determination grace period for the first section during the playback of the first section of the accompaniment.

2. The electronic device according to claim 1, wherein the at least one processor performs the following:
instructing a start of playback of the first section in response to a detection of a first operation on a performance controller in the electronic musical instrument;
if a timing of detection of a second operation on the performance controller that follows the first operation is outside of the determination grace period, instructing a start of playback of the second section; and
if the timing of detection of the second operation is within the determination grace period, not instructing the start of playback of the second section.

3. The electronic device according to claim 1, wherein when the data of the first section indicates that the user is to perform a chord through a plurality of performance operations on the electronic musical instrument, the determination grace period is set to be longer than when the data of the first section indicates that the user is to perform a single note.

4. The electronic device according to claim 1, wherein the determination grace period for the first section is set in accordance with a tempo of the song indicated in the data of the song.

5. The electronic device according to claim 1, wherein the determination grace period for the first section is set in accordance with the number of notes to be played by the user indicated in the data of the first section.

6. An electronic musical instrument, comprising:
the electronic device as set forth in claim 1; and
an performance controller that receives the user operations.

7. A method to be performed by at least one processor in an electronic device, the method comprising, via the at least one processor:
instructing playback of an accompaniment of a song based on a data of the song, the song having a first section and a second section that follows the first section;
setting a determination grace period during which a plurality of operations on an electronic musical instrument by a user are determined to be simultaneously performed for the first section based on the data included in the first section of the music;
advancing the playback of the accompaniment from the first section to the second section when a user operation of the electronic musical instrument is detected outside of the determination grace period for the first section during the playback of the first section of the accompaniment; and
causing the playback of the accompaniment not to advance from the first section to the second section when the user operation of the electronic musical instrument is detected within the determination grace period for the first section during the playback of the first section of the accompaniment.

8. The method according to claim 7,
wherein a start of playback of the first section is instructed in response to a detection of a first operation on a performance controller in the electronic musical instrument;
wherein if a timing of detection of a second operation on the performance controller that follows the first operation is outside of the determination grace period, a start of playback of the second section is instructed; and
wherein if the timing of detection of the second operation is within the determination grace period, the start of playback of the second section is not instructed.

9. The method according to claim 7, wherein when the data of the first section indicates that the user is to perform a chord through a plurality of performance operations on the electronic musical instrument, the determination grace period is set to be longer than when the data of the first section indicates that the user is to perform a single note.

10. The method according to claim 7, wherein the determination grace period for the first section is set in accordance with a tempo of the song indicated in the data of the song.

11. The method according to claim 7, wherein the determination grace period for the first section is set in accordance with the number of notes to be played by the user indicated in the data of the first section.
